(19) United States
(12) Patent Application Publication
(10) Pub. No.: US 2026/0249688 A1
(43) Pub. Date: Aug. 27, 2026

(54) METHOD FOR CONTROLLING A DISPLAY DEVICE, CONTROLLER, AND MOTOR VEHICLE

(71) Applicant: VOLKSWAGEN AKTIENGESELLSCHAFT, Wolfsburg (DE)

(72) Inventors: Johanna SANDBRINK, Braunschweig (DE); Alexander KUNZE, Braunschweig (DE); Yannis TEBAIBI, Braunschweig (DE); Vitalij SADOVITCH, Braunschweig (DE); Matthias SCHACHT, Vordorf (DE)

(21) Appl. No.: 19/163,038

(22) PCT Filed: Feb. 2, 2024
(86) PCT No.: PCT/EP2024/052636

§ 371 Date: Sep. 8, 2025

(30) Foreign Application Priority Data
Mar. 6, 2023 (DE) 10 2023 201 997.3

(51) Int. Cl. B60K 35/234; B60K 35/25; B60K 35/26; B60K 35/28; B60K 35/65; B60K 35/81; B60W 30/09; G08G 1/16

(52) U.S. Cl. CPC B60K 35/234; B60K 35/25; B60K 35/26; B60K 35/265; B60K 35/28; B60K 35/654; B60K 35/81; B60W 30/09; G08G 1/16; B60K 2360/119; B60K 2360/178; B60K 2360/188; B60K 2360/191; B60W 2720/106

(57) ABSTRACT

A method for controlling a display device which is designed to output a virtual marking for an object detected in the surroundings of a motor vehicle to a driver of the motor vehicle. The virtual marking is output by way of the display device so as to indicate the object in a real driving scene. The virtual marking is adapted if the motor vehicle is decelerated by a driver assistance function in order to prevent a collision with the object and the difference between the deceleration of the motor vehicle and a specified threshold for the deceleration falls below a specified threshold, wherein the adapted marking signals that the deceleration has almost reached the threshold at which the control of the motor vehicle is transferred from the driver assistance function to the driver.

The present invention relates to a method for controlling a display device, a controller, and a motor vehicle.

US 2016/0200249 A1 discloses a vehicle head-up display device. This comprises a display control module that receives signals from a plurality of sources and determines one or more warnings based on the signals. The warnings can include at least a lane departure warning, a blind spot warning, a front/rear distance display, a frontal hazard warning, and a side hazard warning. The display device comprises a plurality of light sources that selectively project a plurality of light patterns onto a plurality of locations on a windshield of a vehicle, such that the plurality of light patterns overlays objects outside the vehicle.

Furthermore, US 2019/0077418 A1 discloses a method for displaying braking operations of transport vehicles driving ahead in a transport vehicle. Graphic objects can be generated on a display surface, with each transport vehicle driving ahead being assigned a respective graphic object that indicates the acceleration of the transport vehicle.

Moreover, US 2019/0299855 A1 discloses a vehicle approach system comprising sensors, a vehicle computing device, and a head-up display of an ego vehicle, in order to display graphic elements to a vehicle occupant, for example the driver of the ego vehicle, to indicate approaching vehicles. The graphic approach elements are displayed via a head-up display and projected onto a transparent surface of the ego vehicle, such as windows, the windshield, a screen, or panes. The graphic approach elements indicate the presence of a vehicle near the ego vehicle. Alternatively, the vehicle can be driving in line with the ego vehicle in front and/or behind the ego vehicle.

The object of the present invention is to provide a solution which enables a driver of the motor vehicle to be comprehensively informed regarding the support provided by a driver assistance function.

This object is achieved according to the invention by the subjects of the independent claims. Further possible embodiments of the invention are disclosed in the dependent claims, the description, and the figures. Features, advantages, and possible embodiments described in connection with one of the independent claims are to be understood at least analogously as features, advantages, and possible embodiments of the respective subject matter of the other independent claims, as well as of any possible combination of the subjects of the independent claims, optionally in conjunction with one or more of the dependent claims.

The invention relates to a method for controlling a display device, which is configured to output a virtual marking for an object detected in the surroundings of the motor vehicle to a driver of the motor vehicle. The display device is in particular a head-up display or a head-mounted display, particularly augmented-reality glasses. The driver can therefore continue to perceive the real environment of the motor vehicle through the display device, with the marking being superimposed into this real environment. In the method, the virtual marking is output in a way that indicates the object in a real driving scene. If the display device is a head-up display, it can in particular be a contact-analog head-up display. Using the contact-analog head-up display, display elements such as the virtual marking can be superimposed into the driver's current view in such a way that the driver perceives them as a fixed part of the environment. As a result, for example, a navigation arrow may appear to lie directly on the road. In the case of a safety distance bar, a bar could be displayed to the driver in a windshield area, depending on speed, which indicates how much distance the driver should keep from the vehicle ahead. These contact-analog markings, which overlay the surroundings of the motor vehicle, offer the advantage of directing attention directly toward the marked object, allowing the driver to assess a driving situation of the motor vehicle especially well with very few glances. The contact-analog head-up display is also referred to as an augmented-reality head-up display. In the contact-analog head-up display, optical information is used to characterize elements in the real environment of the vehicle. Example applications include the optical marking of lane boundaries, highlighting pedestrians at the roadside, navigation instructions directly on the road, or marking vehicles detected by the driver assistance function. In the contact-analog head-up display, displays from driver assistance functions such as an Adaptive Cruise Control (ACC) system are shown. Objects lying within the driver's field of view, in particular within a renderable display area of the head-up display, can be marked in order to show the driver that the driver assistance function has detected them and is controlling the vehicle accordingly. The object that is marked by means of the virtual marking is an object detected by a driver assistance function of the motor vehicle and to which the motor vehicle is being controlled. In the present case, the motor vehicle is decelerated by the driver assistance function in order to prevent a collision with the object.

In the method, it is also provided that the virtual marking is adapted if the motor vehicle is decelerated by the driver assistance function in order to prevent a collision with the object and a difference between the deceleration of the motor vehicle and a predefined limit value for the deceleration falls below a predefined threshold. In this case, the adapted marking signals that the deceleration of the motor vehicle has almost reached the limit value at which control of the motor vehicle is transferred from the driver assistance function to the driver. Without the method, the driver would not be able to recognize how close an active control system of the motor vehicle, operated by the driver assistance function, is to a permissible functional control limit and at what point they must be particularly alert to potentially intervene in the control of the motor vehicle.

The limit value can, for example, be predefined by legal requirements. In other words, the limit value can be selected depending on statutory requirements to ensure that the motor vehicle complies with legal regulations. The limit value defines the maximum deceleration that the motor vehicle may have when the vehicle is longitudinally controlled by the driver assistance function, or when the driver of the motor vehicle is assisted in longitudinal control by the driver assistance function. If the predefined limit value for the deceleration must be exceeded in order to prevent a collision of the motor vehicle with the object, then the driver must take over control of the motor vehicle. The driver may brake the motor vehicle with a deceleration greater than the limit value. To direct the driver's attention particularly well to the marked object, the virtual marking for the object can be output via the display device so as to overlay the real driving scene. It may thus appear to the driver in the augmented-reality head-up display as if the virtual marking and the object area at least partially overlapping. In particular, it can be provided that by means of the virtual marking, an optical property in the augmented-reality head-up display or augmented-reality head-mounted display is adapted for the driver. Thus, it appears to the driver as though the object itself exhibits the optical property adapted by the virtual marking. This can direct the driver's attention particularly well to the object with respect to which the motor vehicle is being controlled by the driver assistance function. The method enables the driver to be particularly well prepared to take over control of the motor vehicle in the near future should the deceleration triggered by the driver assistance function approach the limit value.

In one possible embodiment of the invention, it is provided that the marking is adapted by adjusting a coloration of the object and/or an animation of the object. Adjusting the coloration of the object is to be understood as meaning that the object is, for example, colored orange by the virtual marking. Depending on the distance between the current deceleration of the motor vehicle and the predefined limit value for the deceleration, the object may be displayed in different colors by means of the virtual marking. If the distance between the current deceleration of the motor vehicle and the limit value is relatively large and thus greater than the predefined threshold, the object may be displayed in green by the virtual marking, for example. If the deceleration of the motor vehicle lies between the threshold and the limit value, or corresponds to the threshold, then the object may be displayed in orange by the virtual marking. If the deceleration of the motor vehicle becomes equal to or greater than the predefined limit value, then the object may be displayed in red by the virtual marking. The adaptation of the animation of the object is to be understood as a dynamic change of the object's appearance by means of the virtual marking. For example, the object may be displayed alternately enlarged and then reduced again in size by an overlay of the virtual marking to draw the driver's attention to the object. By adapating the color or dynamically changing the appearance of the object using the virtual marking, the driver's attention can be particularly well directed to the object as well as to the information represented by the virtual marking, which states that the driver may need to take over control of the motor vehicle from the driver assistance function in the near future.

In another possible embodiment of the invention, the adaptation comprises displaying the object in a blinking manner by means of the virtual marking, where the blinking display constitutes a dynamic adaptation of the object's appearance and therefore represents an animation of the object. In this case, the blinking frequency increases as the difference between the deceleration of the motor vehicle and the predefined limit value becomes smaller. The dynamics of the blinking can thus indicate to the driver that the probability of having to take over control of the motor vehicle in the near future is increasing or decreasing. Moreover, the blinking frequency can signal whether the takeover will likely be required very soon or later. The more the blinking frequency increases, the sooner the driver must take over control of the motor vehicle. This allows the driver to prepare particularly well for the takeover from the driver assistance function.

In another possible embodiment of the invention, it is provided that in addition to adapting the marking, an acoustic notification in the vehicle interior is triggered. This acoustic notification indicates that the deceleration has approached the limit value closer than the predefined threshold, and therefore the driver may need to take over control of the motor vehicle from the driver assistance function in the near future, should the deceleration reach the limit value. The acoustic notification enables the driver to not only be visually but also acoustically alerted to the possibly imminent takeover of control from the driver assistance function. This minimizes the risk that the driver does not perceive the information indicating that the deceleration of the motor vehicle has already approached the limit value closer than the threshold.

In this context, it may in particular be provided that the acoustic notification comprises a voice output or a warning tone in the vehicle interior. The warning tone can capture the driver's attention especially well, since the warning tone can put the driver into an alert state. The voice output can deliver the information with particular precision to the driver. For example, the voice output can be: “Deceleration of the motor vehicle is approaching the limit value. Prepare to take over control of the motor vehicle.” This ensures that the driver is particularly well informed about which action may be required of them in the near future. Thus, the driver can prepare particularly well for taking over control of the motor vehicle.

In another possible embodiment of the invention, it is provided that an outer contour of the marking corresponds to an outline of the object, whereby the marking can be output so as to fully cover the object. In other words, the marking can have essentially the same contour or outline as the object in the driver's field of view. This allows the visual appearance of the object to be adapted especially effectively for the driver. For example, the coloration of the object, as perceived by the driver, can be adapted in this way. In particular, this makes it possible to adapt only the optical properties of the object in the driver's field of view via the virtual marking, while the driver's view of the real driving scene is minimally impaired. The driver thereby retains a particularly good view of the real environment of the motor vehicle.

In another possible embodiment of the invention, it is provided that in addition to adapting the marking, a notification in text form and/or in the form of an icon is triggered, which overlays the real driving scene. This means that the notification in text form and/or in the form of an icon is introduced into the driver's field of view by the display device, in particular by projection. The driver can thereby perceive the text or icon notification especially well without diverting their gaze from the real driving scene in the surroundings of the motor vehicle. The text notification or icon notification, for example, in the form of an exclamation mark or warning triangle, makes it possible to provide the driver with additional optical information as to why the object is being marked with the virtual marking, so that the driver can easily determine with little effort that they may be expected to take over control of the motor vehicle in the near future. Accordingly, the driver can prepare especially well for taking over control. The text notification can, for example, state: “Deceleration of the motor vehicle is approaching the limit value. Prepare to take over control of the motor vehicle.”

In another possible embodiment of the invention, it is provided that in addition to adapting the marking, ambient lighting in the vehicle interior and/or vibration of a vehicle seat and/or vibration of a steering wheel is activated or adapated if it is determined that the difference between the deceleration of the motor vehicle and the predefined limit value for the deceleration has fallen below the predefined threshold. This means that in addition to marking the object in their field of view with the virtual marking, the driver is alerted to the possible imminent takeover of control of the motor vehicle by adapting the color and/or output dynamics of the ambient lighting in the vehicle interior and/or by initiating or changing vibration of the seat and/or steering wheel. By adapting the ambient lighting or vibration of the steering wheel and/or seat, the driver can be placed especially well into a state of heightened alertness, enabling them to prepare particularly well to take over control of the motor vehicle if necessary.

The invention further relates to a controller, which is configured to carry out a method as has already been described above in connection with the inventive method for controlling a display device. In particular, the controller is configured to control the display device and thereby trigger the output of the virtual marking for the object detected in the surroundings of the motor vehicle to the driver. The controller can thus trigger the characteristic output of the virtual marking for the object in the real driving scene by means of the display device. Furthermore, the controller can trigger adaptation of the virtual marking when the motor vehicle is decelerated by the driver assistance function to prevent a collision with the object, and the difference between the deceleration of the motor vehicle and the predefined limit value for the deceleration falls below the predefined threshold. The controller may be configured to compare the deceleration of the motor vehicle triggered by the driver assistance function with the predefined limit value and thus evaluate the difference relative to the predefined threshold. The controller can therefore determine whether the virtual marking needs to be adapted. If it is determined by the controller that the virtual marking is to be adapted, the controller drives the display device such that the display device adapts the virtual marking according to the control by the controller.

The invention further relates to a motor vehicle comprising a controller as has already been described in connection with the inventive controller.

Further features of the invention may emerge from the following description of the figures and from the drawing. The features and feature combinations mentioned in the description above, as well as the features and feature combinations mentioned below in the description of figures and/or shown alone in the figures can be used not only in the respective indicated combinations but also in other combinations or individually without departing from the scope of the invention.

The drawing shows in:

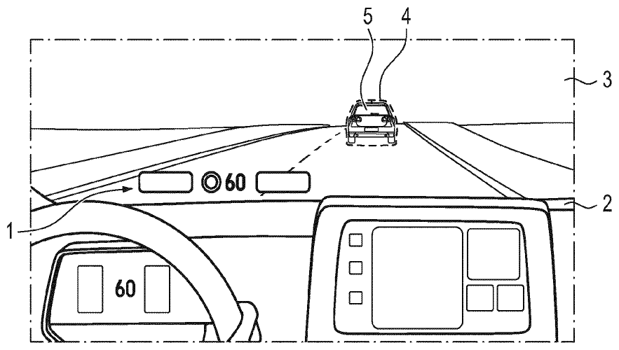

FIG. 1 A view of a driver of a motor vehicle looking at a contact-analog head-up display, in which an object in a real driving scene is marked with a virtual marking.

In FIG. 1, a contact-analog head-up display (1), which is also referred to as an augmented-reality head-up display, is shown from the perspective of a driver of a motor vehicle (2). The head-up display (1) is a display device that allows the driver to maintain their line of sight and thus their head position when looking at a windshield (3) of the motor vehicle (2), with information being projected into their field of view, overlaid onto the windshield (3). The head-up display (1) is a display device configured to output a virtual marking (4) for an object (5) detected in the surroundings of the motor vehicle (2) for the driver of the motor vehicle (2).

The motor vehicle (2) comprises a controller configured to control the display device, in this case, the contact-analog head-up display (1), according to the method described below. In the method carried out by the controller for controlling the display device, specifically the contact-analog head-up display (1), the virtual marking (4) is output to characteristically indicate the object (5) in a real driving scene. As can be seen in FIG. 1, the object (5) in the driver's field of view is thus marked by means of the virtual marking (4). Here, an outer contour of the marking (4) corresponds to an outline of the object (5), whereby the virtual marking (4) can be output completely covering the object (5). As shown in FIGS. 1, the virtual marking (4) overlays the object (5) in the driver's field of view. Thus, the object (5) is overlaid by the virtual marking (4). To ensure that the driver can still see the object (5) despite the overlay with the marking (4), the virtual marking (4) may be at least partially transparent. In the present case, the object (5) is a vehicle, in particular another motor vehicle. The virtual marking (4) directs the attention of the driver of the motor vehicle (2) to the object (5) detected in the surroundings of the motor vehicle (2).

The motor vehicle (2) is configured to be controlled by means of a driver assistance function. This means that the driver of the motor vehicle (2) can be assisted in controlling the motor vehicle (2), or the driver assistance function is configured to perform the longitudinal and/or lateral control of the motor vehicle (2) at least semi-automatically, in particular fully automatically.

If the motor vehicle (2) is decelerated by the driver assistance function to prevent a collision with the object (5), and the difference between the deceleration of the motor vehicle (2) and a predefined limit value for the deceleration falls below a predefined threshold, then the virtual marking (4) is adapted. This means that, based on the adapted virtual marking (4), the driver of the motor vehicle (2) can recognize that it has been determined that the difference, and thus the distance, between the current deceleration of the motor vehicle (2) and the predefined limit value is smaller than the predefined threshold. In other words, the adapted virtual marking (4) indicates that the current deceleration of the motor vehicle (2) has approached the predefined limit value closer than the predefined threshold. The limit value, in particular, defines a maximum deceleration with which the motor vehicle (2) may be decelerated when under control of the driver assistance function. A deceleration of the motor vehicle (2) exceeding the limit value may only be performed by the driver of the motor vehicle (2). The adapted marking (4) thus signals to the driver that the current deceleration of the motor vehicle (2) has almost reached the limit value. As soon as the deceleration of the motor vehicle (2) reaches the limit value, control of the motor vehicle (2) is transferred from the driver assistance function to the driver. If it is determined that the current deceleration of the motor vehicle (2) with which the motor vehicle (2) is decelerated by the driver assistance function is not sufficient to prevent a collision of the motor vehicle (2) with the object (5), and avoiding the collision requires a deceleration of the motor vehicle (2) equal to or greater than the limit value, then control of the motor vehicle (2) is handed over to the driver, so that they can decelerate the motor vehicle (2) sufficiently to prevent the collision. Through the respective adaptation of the appearance of the object (5) in the contact-analog head-up display (1) by the virtual marking (4), the driver of the motor vehicle (2) can thus be informed particularly well about whether the driver assistance function controlling the motor vehicle (2) is approaching its respective limits for the control of the motor vehicle (2), and therefore whether control of the motor vehicle (2) must be taken over by the driver if the driver assistance function actually reaches the limits.

In the present case, it is provided that the coloration of the object (5) is adapted by adapting the virtual marking (4). Alternatively or additionally, an animation, and thus a dynamic change in the appearance of the object (5), can be adapted by adapting the virtual marking (4). Here, the adaptation may involve displaying the object (5) in a blinking manner by means of the virtual marking (4). In particular, a frequency of the blinking may increase as the difference between the deceleration of the motor vehicle (2) and the predefined limit value decreases. A criticality with respect to the possibly imminent takeover of control of the motor vehicle (2) by the driver, and thus the proximity of the driver assistance function to its system limits, in particular system limits of a speed control, is indicated by the adaptation of the virtual marking (4). This criticality is given by the fact that the difference between the deceleration of the motor vehicle (2) and the predefined limit value is smaller than the predefined threshold. The criticality can thus be indicated by the blinking display of the object, in particular of the vehicle driving ahead. In this case, the frequency increases as the deceleration approaches the limit value. The virtual marking (4) can alternatively or additionally be displayed in a shaking or vibrating manner, with the shaking or vibrating increasing the smaller the difference between the deceleration of the motor vehicle (2) and the predefined limit value becomes. The smaller the difference between the deceleration of the motor vehicle (2) and the limit value, the more strongly a transparency of the virtual marking (4) can be reduced.

In order to place the driver in a state of heightened alertness and to make them particularly well aware that the driver assistance function is reaching its system limits, and that control of the motor vehicle (2) may therefore have to be taken over by the driver, an acoustic notification can be output in the vehicle interior of the motor vehicle (2) in addition to adapting the virtual marking (4). This acoustic notification may be a warning tone or a voice output. For example, the voice output can be: “ACC near system limit.” Alternatively or additionally to the output of the acoustic notification, ambient lighting in the interior of the motor vehicle (2) can be adapted, in particular with regard to blinking or a change of color, and/or the steering wheel of the motor vehicle (2) can vibrate and/or the driver's seat of the motor vehicle (2) can vibrate. The warning tone may, for example, be a beep.

In the method, a visual representation of the object (5), which the driver assistance function of the motor vehicle (2) is regulating against, is adapted in the contact-analog head-up display (1) by means of the virtual marking (4) when the difference between the deceleration of the motor vehicle (2) and the predefined limit value has fallen below the predefined threshold, and thus the critical deceleration is soon reached at which the driver must take over control of the motor vehicle (2).

In the contact-analog head-up display (1), objects (5) detected by sensors and cameras of the motor vehicle (2), and against which driver assistance functions of the motor vehicle (2) regulate, can be marked. In this case, the respective object (5) can be marked by means of the virtual marking (4). A green marking (4) of the object (5) can characterize that the object (5) is being regulated against by the driver assistance function. The object (5) can thereby be marked only situationally and not permanently by the virtual marking (4). A red marking (4) of the object (5) can characterize that a functional limit of the driver assistance function has been reached and that the maximum deceleration permitted for the driver assistance function will likely not suffice to prevent a collision of the motor vehicle (2) with the object (5), and that therefore the driver must intervene in the control of the motor vehicle (2). Within the framework of the method described for controlling the display device, an additional display category is provided, which informs the driver that the driver assistance function can still regulate, but that the deceleration of the motor vehicle (2) is relatively high and therefore a takeover request may occur, and that the driver should therefore be particularly alert. In the event that a defined high deceleration is applied by the driver assistance function in the motor vehicle (2), the marking of the object (5) is changed in color upon a trigger from a function control unit, in particular so that the object (5) is displayed marked in orange. By this adaptation of the marking of the object (5), the driver is signaled, analogously to a warning module and to the color logic used in human-machine interface, that a high deceleration is required and that a system limit of the driver assistance function may soon be reached, upon which the driver must take over control of the motor vehicle (2). The color of the virtual marking (4) therefore characterizes a current ability of the driver assistance function to maintain or regulate a predefined time gap to the preceding vehicle. In addition to distance, the actual speed of the motor vehicle (2) and of the preceding vehicle, as well as the ability of the driver assistance function to control the motor vehicle (2) given a relative speed between the motor vehicle (2) and the preceding vehicle, are taken into account as influencing factors. The virtual marking (4) thus enables a reliability display of the driver assistance function and not per se a “you are driving too close” warning. By means of the virtual marking (4), system limits of the driver assistance function are communicated dynamically and situationally. For support, an icon and/or a text can be added to the virtual marking (4), which communicates the system limits particularly more clearly compared to the color alone. In the case of the aforementioned orange marking of the object (5) by means of the virtual marking (4), the additional display can read: “ACC system near system limit.” In the case of the red marking of the object (5) by means of the virtual marking (4), the additional display can read: “ACC system limits exceeded.”

As an alternative to the embodiment of the display device as a contact-analog head-up display, the display device can be a head-mounted display, in particular augmented-reality glasses.

Overall, the invention shows how a criticality display of control objects can be implemented in an augmented-reality head-up display.

### LIST OF REFERENCE NUMERALS

1 Contact-analog head-up display
2 Motor vehicle
3 Windshield
4 Virtual marking
5 Object

1-10. (canceled)

11. A method of controlling a display device that is configured to output a virtual marking for an object detected in the surroundings of a motor vehicle to a driver of the motor vehicle, the method comprising:
outputting, by the display device, the virtual marking indicating the object in a real driving scene; and
adapting the virtual marking to generate an adapted marking when the motor vehicle is decelerated by a driver assistance function to prevent a collision with the object and a difference between a deceleration value of the motor vehicle and a predefined threshold value for the deceleration falls below a predefined threshold, wherein the adapted marking is formed to signal that the deceleration value has almost reached the threshold value at which a control of the motor vehicle is transferred from the driver assistance function to the driver.

12. The method according to claim 11, wherein the step of adapting the virtual marking comprises at least one of adjusting a coloration of the object or an animation of the object.

13. The method according to claim 11, wherein the step of adapting the virtual marking comprises representing the object as a flashing object in the virtual marking, and increasing a flashing frequency as the difference between the deceleration of the motor vehicle and the predefined threshold value decreases.

14. The method according to claim 11, which comprises, in addition to adapting the virtual marking, triggering an acoustic notification in a vehicle interior of the motor vehicle.

15. The method according to claim 14, wherein the acoustic notification comprises at least one of a voice output or a warning tone.

16. The method according to claim 11, wherein an outer contour of the marking corresponds to an outline of the object, and selectively displaying the marking to fully cover the object.

17. The method according to claim 11, which comprises, in addition to adapting the marking, outputting a notification in at least one of a text form or a form of an icon overlaying the real driving scene.

18. The method according to claim 11, which further comprises adapting or activating at least one of the following when the difference between the deceleration of the motor vehicle and the predefined limit value for the deceleration falls below the predefined threshold: an ambient lighting in a vehicle interior of the motor vehicle, a vibration of a vehicle seat, and/or a vibration of a steering wheel.

19. A controller for a display device in a motor vehicle, the controller comprising:
an input for receiving information when an object is detected in a surrounding of the motor vehicle;
an output connected to the display device for displaying, via the display device, a virtual marking indicating the object in a real driving scene; and
a processor configured to adapt the virtual marking to generate an adapted marking when the motor vehicle is decelerated by a driver assistance function to prevent a collision with the object and a difference between a deceleration value of the motor vehicle and a predefined threshold value for the deceleration falls below a predefined threshold, wherein the adapted marking is formed to signal that the deceleration value has almost reached the threshold value at which a control of the motor vehicle is transferred from the driver assistance function to the driver.

20. A motor vehicle, comprising a controller according to claim 19.
